(19) United States
(12) Patent Application Publication
(10) Pub. No.: US 2008/0005160 A1
(43) Pub. Date: Jan. 3, 2008

(54) Assembly Sensitive Dynamic Classloading Of .Net Types in J#

(75) Inventor: Pratap Lakshman, Hyderabad (IN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/428,166

(22) Filed: Jun. 30, 2006

(51) Int. Cl. G06F 17/00

(52) U.S. Cl. 707/103 R

(57) ABSTRACT

A request is received for a class object from a requester, wherein the class object corresponds to a type object from an assembly. The requested class object is returned to the requester.

### BACKGROUND

The Microsoft® .NET Framework is a development and execution environment that allows different programming languages and libraries to work together to create Microsoft Windows® based applications that are easy to integrate with other networked systems. The .NET Framework includes a Common Language Runtime (CLR) component and Framework Class Libraries (FCL). CLR serves as an execution environment for .NET applications. The FCL provide a collection of classes or types that may be used to build .NET applications. The .NET Framework supports various programming languages such as Visual C#, Visual Basic NET, and Visual J# .NET.

Microsoft Visual J# .NET is a development tool that developers who are familiar with the Java™-language syntax can use to build applications and services on the .NET Framework (“Java” is a trademark of Sun Microsystems, Inc.). It integrates the Java™-language syntax into the Visual Studio .NET shell. Microsoft Visual J# .NET is not a tool for developing applications intended to run on a Java™ Virtual Machine. Applications and services built with Visual J# .NET will run only on the .NET Framework.

J# code is compiled into intermediate code (called Microsoft Intermediate Language (MSIL)) and placed in an assembly. The intermediate code can be compiled by the CLR at runtime. In the .NET Framework, an assembly is a collection of one or more files that are versioned and deployed as a unit. An example of an assembly includes a dynamic link library (DLL).

A type is a class-like entity in the .NET Framework. A type object represents an instance of a type. A type may represent such things as classes, arrays, interfaces, pointers, and enumerations. Type objects may have the same name, but have different characteristics. Assembly information may be used to distinguish between type objects with the same name.

A collection of .NET types can be grouped together in an assembly. When a type is accessed, the CLR needs to know the name of the type and the assembly that contains the definition of the type so that the CLR can load the correct assembly, find the type, and use the type.

J# works with classes, but J# does not understand the concept of assemblies. Usually, J# is provided a class object corresponding to a type object from an assembly during classloading. Often, versioned types are stored in different assemblies. For example, a type “foo” could be stored in assembly “foo_version1.dll”. A later version of type “foo” could be stored in assembly “foo_version2.dll”. But current J# classloaders do not support loading of two .NET types with the same name from two different assemblies.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments of the invention may load unique class objects corresponding to two .NET type objects with the same name residing in different assemblies using the same classloader. In one embodiment, the classloader is provided a classname and an assembly name and the class object corresponding to the type object from the requested assembly is returned. In another embodiment, the classloader is provided a type object and the corresponding class object is returned.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram of an example operating environment to implement embodiments of the invention;

FIG. 2 is a block diagram of a type cache and a class cache in accordance with an embodiment of the invention;

FIG. 3 is a flowchart of the logic and operations of classloading in accordance with an embodiment of the invention;

FIG. 4A is a block diagram of a type cache and a class cache in accordance with an embodiment of the invention;

FIG. 4B is a block diagram of a type cache and a class cache in accordance with an embodiment of the invention; and

FIG. 5 is a flowchart of the logic and operations of classloading in accordance with an embodiment of the invention.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

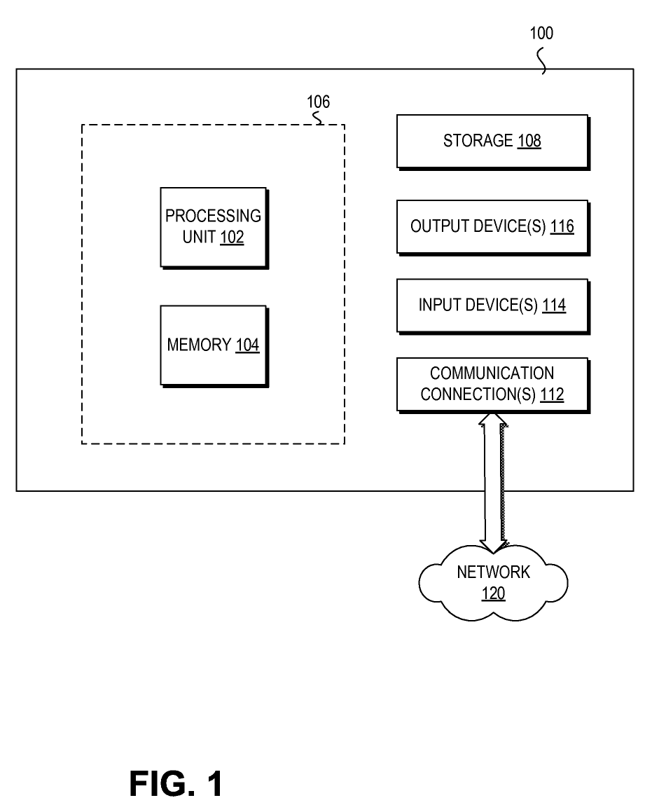

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing systems, environments, and/or configurations that may be suitable for use with embodiments described herein including, but not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

Although not required, embodiments of the invention will be described in the general context of computer readable instructions, such as program modules, being executed by one or more computers or other devices. Computer readable instructions may be distributed via computer readable media (discussed below). Generally, program modules include routines, programs, objects, components, data structures, etc., that perform particular tasks or implement particular abstract data types. Typically, the functionality of the program modules may be combined or distributed as desired in various environments.

FIG. 1 shows an exemplary system for implementing one or more embodiments of the invention in a computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features and/or functionality. For example, device 100 may also include additional storage (e.g., removable and/or non-removable) including, but not limited to, magnetic or optical disks or tape. Such additional storage is illustrated in FIG. 1 by storage 108. In one embodiment, computer readable instructions to implement embodiments of the invention may be stored in storage 108. Storage 108 may also store other computer readable instructions to implement an operating system, an application program, and the like.

The term “computer readable media” as used herein includes both computer storage media and communication media. Computer storage media includes volatile and nonvolatile, removable and non-removable media implemented in any method or technology for storage of information such as computer readable instructions, data structures, program modules, or other data. Memory 104 and storage 108 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communication connection(s) 112 that allow the device 100 to communicate with other devices, such as with other computing devices through network 120. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may also have input device(s) 114 such as keyboard, mouse, pen, voice input device, touch input device, laser range finder, infra-red cameras, video input devices, and/or any other input device. Output device(s) 116 such as one or more displays, speakers, printers, and/or any other output device may also be included.

Those skilled in the art will realize that storage devices utilized to store computer readable instructions may be distributed across a network. For example, a remote computer accessible via network 120 may store computer readable instructions to implement one or more embodiments of the invention. A local or terminal computer may access the remote computer and download a part or all of the computer readable instructions for execution. Alternatively, the local computer may download pieces of the computer readable instructions as needed, or distributively process by executing some instructions at the local terminal and some at the remote computer (or computer network). Those skilled in the art will also realize that by utilizing conventional techniques known to those skilled in the art, all or a portion of the computer readable instructions may be carried out by a dedicated circuit, such as a Digital Signal Processor (DSP), programmable logic array, and the like.

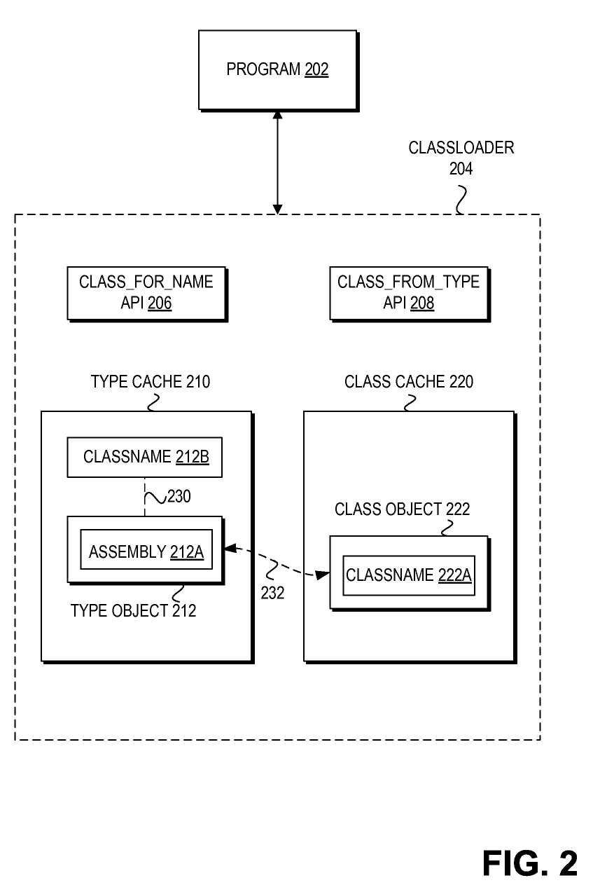

Turning to FIG. 2, a block diagram of a classloader 204 in accordance with embodiments of the invention is shown. Classloader 204 loads class objects in response to requests from a program 202 during program 202 runtime. In one embodiment, program 202 is coded in J# and classloader 204 includes a J# classloader. The class objects loaded by classloader 204 correspond to .NET type objects stored in assemblies.

In one embodiment, program 202 and classloader 204 may be implemented on computing device 100. Program 202 and classloader 204 may be stored on computing device 100, on remote systems that may communicate with computing device 100 over network 120, or any combination thereof.

Classloader 204 includes a class_for_name application program interface (API) 206 and a class_from_type API 208. In one embodiment, class_for_name API 206 is provided a classname and an assembly name and the corresponding class object is returned. In one embodiment, class_from_type API 208 is provided a type object and the corresponding class object is returned.

Classloader 204 may include a type cache 210 and a class cache 220. Type cache 210 may include a type object 212. A mapping 230 may be used to map between type object 212 and a classname 212B in type cache 210 associated with type object 212. Type object 212 may include an assembly 212A. Assembly 212A includes the assembly where the type object is located. Assembly 212A may include a reference to the location of the assembly and the assembly name.

Class cache 220 may include a class object 222 that includes a classname 222A. Class object 222 represents corresponding type object 212. A mapping 232 may be used to map between class object 222 and type object 212. Mapping 232 may include pointers and the like. As will be described below, embodiments of the invention maintain a one-to-one correspondence between class objects and type objects.

A single object is shown in each cache in FIG. 2 for the sake of clarity, but it will be understood that each cache may maintain numerous objects. Also, it will be understood that type objects and class objects may be implemented as references to type objects and class objects, such as pointers, for operations with type cache 210 and class cache 220 as described herein.

Embodiments of the invention use type cache 210 and class cache 220 to load classes in an assembly-sensitive manner at runtime. A one-to-one correspondence is maintained between type objects and class objects. This one-to-one correspondence enables roundtripping, that is, given a class object, the corresponding type object may be determined, and from this type object, the corresponding class object may be determined.

Embodiments herein also include a two-phase lookup scheme. Classloader 204 may perform looks ups in class cache 220 and type cache 210 to find the desired class object. This two-phase lookup ensures that the class object from the correct assembly is returned to program 202.

Conventional classloaders may load a class object based on a classname provided by the caller, such as a program. The classloader may also accept an assembly name from the caller. The classloading logic may look for the requested class object by classname in the following sequence: 1) look for the class object in an internal cache of class objects that have been loaded previously, 2) look for the class object in the calling assembly, and 3) look for the class object in all loaded assemblies.

If the class object is found, the classloader checks the assembly to which the class object belongs against the assembly referenced by the assembly name provided. If the assemblies match, then the class object is stored in the internal cache for future retrieval and returns the class object to the caller. If the assemblies do not match, then the classloader throws an exception. Thus, conventional classloaders do not support loading two type objects (i.e., class objects) with the same name from different assemblies. Once a class object associated with a particular assembly has been loaded, a class object with the same classname cannot be loaded from a different assembly. Also, conventional classloaders do not offer the capability to find and return the underlying class object given a particular type object.

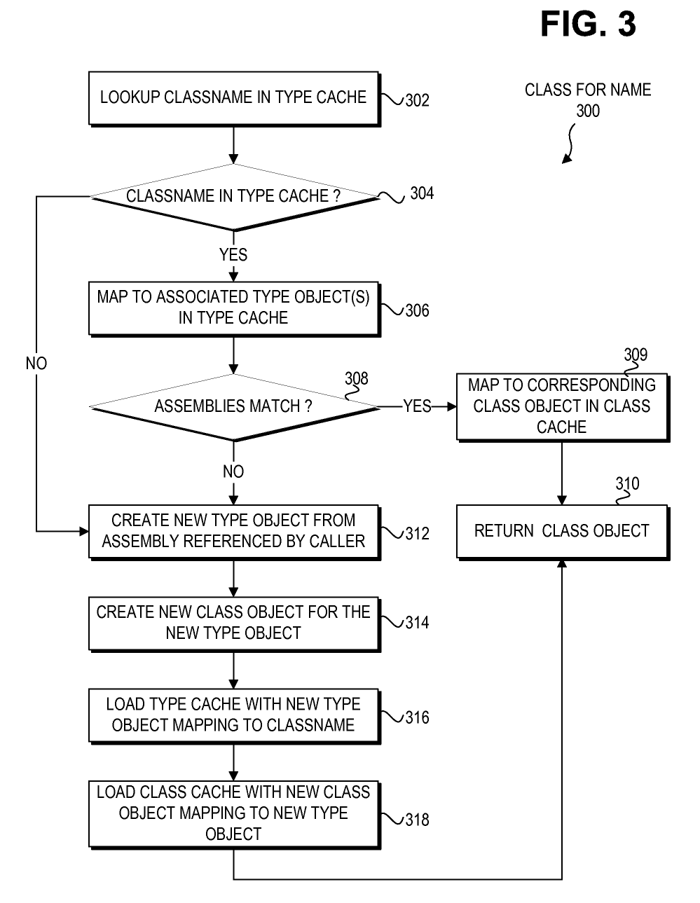

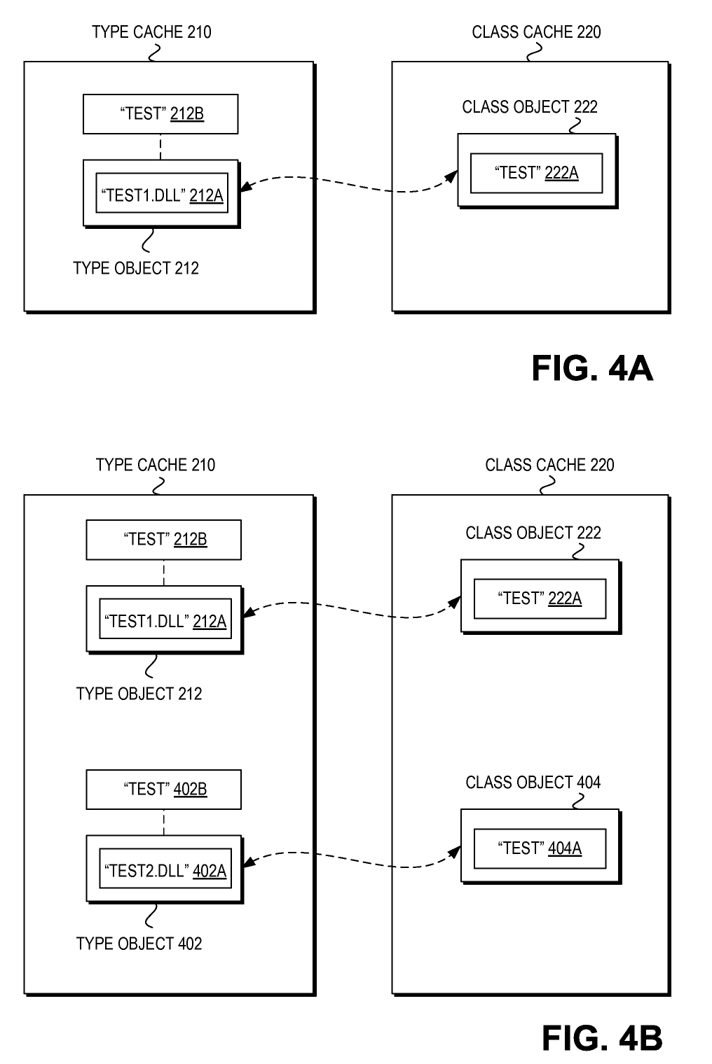

Turning to FIGS. 3, 4A and 4B, an embodiment of the logic and operations of class_for_name API 206 is shown. In one embodiment, class_for_name API 206 may be called by program 202 using Class.forName(assemblyname, classname) where assemblyname and classname are both string arguments.

Starting in block 302 of flowchart 300, a lookup of the type cache is performed using the classname provided by the caller. Continuing to decision block 304, if the classname is not found, then the logic proceeds to block 312 (discussed below). In this case, a class having the provided classname has not been loaded. If the classname is found in the type cache, then the logic continues to block 306.

In block 306, the logic maps to the one or more type objects in the type cache associated with the provided classname. It will be appreciated that more than one type object may be associated with a classname. Next, in decision block 308, the logic determines if the assembly referenced by the assembly name provided by the caller matches the assembly of the type object(s). In one embodiment, the provided assembly name is compared to an assembly name of a type object. It will be appreciated that if multiple matching classnames are found in the type cache, then the logic compares each of the associated assemblies of the type objects having matching classnames to the provided assembly name to determine if a match occurs.

If the assemblies match, then the logic proceeds to a block 309 to map to the corresponding class object in the class cache and then to block 310 to return the class object to the caller. As used herein, returning a class object includes returning a reference to the class object, such as a memory address.

Referring to FIG. 4A, type object 212 has associated classname “test” 212B and assembly “test1.dll” 212A. In accordance with the logic of flowchart 300, if the caller requests classname “test” from the assembly named “test1.dll”, then the logic will return class object 222 since classname 212B and the assembly name of assembly 212A of type object 212 match the request.

In decision block 308, if the assemblies do not match, then the logic continues to block 312. This is the case where a class having the provided classname has been loaded from an assembly other than the assembly name provided in the request.

In block 312, a new type object is created from the assembly referenced by the caller in the provided assembly name. Next, in block 314, a new class object corresponding to the new type object is created.

Continuing to block 316, the type cache is loaded with the new type object. When loaded, the new type object is mapped to an associated classname in the type cache. Next, in block 318, the class cache is loaded with the new class object and mapped to the new type object. After block 318, the logic proceeds to block 310 to return the new class object to the caller.

Referring to FIG. 4B, assume that the caller requested classname “test” and assembly name “test2.dll.” The logic of flowchart 300 does not find a matching classname and assembly in type cache 210. So the logic creates a new type object 402 mapped to classname “test” 402 B. A new class object 404 having classname “test” 404A is created that represents type object 402. A mapping is setup between test object 402 and class object 404. Class object 404 is then returned to the caller. FIG. 4B shows a one-to-one correspondence between type objects and class objects. Thus, classname “test” could be requested again for either assembly “test1.dll” or “test2.dll” and the correct class object would be returned.

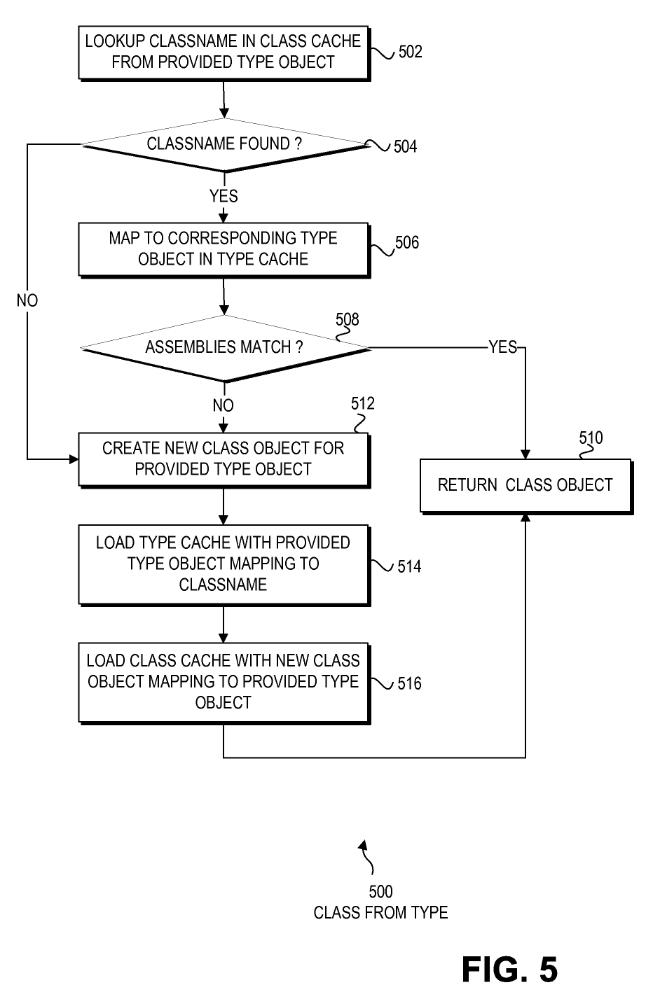

Turning to FIG. 5, an embodiment of the logic and operations of class_from_type API 208 is shown. In one embodiment, class_from_type API 208 may be called by program 202 using Class.fromType(Type1) where argument Type1 is a type object. The logic of flowchart 500 ensures a one-to-one correspondence between class objects and type objects that enables roundtripping. In this way, given a type object, the corresponding class object may be found.

Starting in block 502 of flowchart 500, a lookup of the classname in the class cache from the type object provided by the caller is performed. The provided type object includes a type name that is used as the classname for the lookup in the class cache.

Next, in decision block 504, the logic determines if the classname is found in the class cache. If the classname is not found, then the logic proceeds to block 512 (discussed below). If the classname is found, then the logic maps to the corresponding type object in the type cache, as shown in block 506. After block 506, the logic proceeds to decision block 508 to determine if the assembly of the provided type object matches the assembly of the type object in the type cache. In one embodiment, the assembly names are compared to determine a match. If the assemblies match, then the logic continues to block 510 to return the corresponding class object from the class cache. If the assemblies do not match, then the logic proceeds to block 512.

In block 512, a new class object is created to represent the type object provided by the caller. Next, in block 514, the type cache is loaded with the provided type object. The classname associated with the type object is mapped to the provided type object. This classname is the type name of the provided type object.

Continuing to block 516, the new class object is loaded in the class cache corresponding to the type object with a mapping to the type object in the type cache. Next, the new class object is returned to the caller, as shown in block 510.

Embodiments of the invention provide classloading of .NET types in an assembly sensitive manner from J# code. Embodiments herein enable a program to request class objects having the same name from different assemblies. A program may request a class object from a particular assembly even though a class object with the same name from a different assembly has been previously loaded.

Various operations of embodiments of the present invention are described herein. In one embodiment, one or more of the operations described may constitute computer readable instructions stored on computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize. These modifications may be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
receiving a request for a class object from a requester, wherein the class object corresponds to a type object from an assembly; and
returning the requested class object to the requester.

2. The method of claim 1 wherein the request includes a provided classname and a provided assembly name associated with the class object.

3. The method of claim 2 wherein returning the class object includes:
determining that a classname associated with a type object matches the provided classname;
determining that an assembly of the type object matches an assembly referenced by the provided assembly name;
mapping from the type object to a class object; and
returning the class object to the requester as the requested class object.

4. The method of claim 2 wherein returning the class object includes:
determining that a classname associated with a type object matches the provided classname;
determining that an assembly of the type object does not match an assembly referenced by the provided assembly name;
creating a new type object from the assembly referenced by the provided assembly name;
creating a new class object corresponding to the new type object, wherein the new class object maps to the new type object; and
returning the new class object to the requester as the requested class object.

5. The method of claim 2 wherein returning the class object includes:
determining that a classname associated with a type object does not match the provided classname;
creating a new type object from an assembly referenced by the provided assembly name;
creating a new class object corresponding to the new type object, wherein the new class object maps to the new type object; and
returning the new class object to the requester as the requested class object.

6. The method of claim 1 wherein the request includes a provided type object corresponding to the class object, wherein the provided type object includes a provided type name.

7. The method of claim 6 wherein returning the class object includes:
determining that a classname of a class object matches the provided type name;
mapping from the class object having the classname to a type object;
determining that an assembly of the type object matches an assembly referenced by the provided type object; and
returning the class object to the requester as the requested class object.

8. The method of claim 6 wherein returning the class object includes:
determining that a classname of a class object matches the provided type name;
mapping from the class object having the classname to a type object; and
determining that an assembly of the type object does not match an assembly referenced by the provided type object;
creating a new class object corresponding to the provided type object, wherein the new class object maps to the provided type object;
associating the classname with the provided type object; and
returning the new class object to the requester as the requested class object.

9. The method of claim 6 wherein returning the class object includes:
determining that a classname of a class object does not match the provided type name;
creating a new class object corresponding to the provided type object, wherein the new class object maps to the provided type object;
associating the classname with the provided type object; and
returning the new class object to the requester as the requested class object.

10. One or more computer readable media including computer readable instructions that, when executed, perform the method of claim 1.

11. A method of communication between a program and a classloader during program runtime, comprising:
receiving, by the classloader, a class_for_name call from the program, wherein the class_for_name call includes call parameters comprising a classname and an assembly name associated with a requested class object; and
issuing, by the classloader, a class_for_name return, wherein the class_for_name return includes return parameters comprising the requested class object.

12. The method of claim 11 wherein issuing, by the classloader, the class_for_name return includes:
determining that a classname associated with a type object in a type cache matches the provided classname;
determining that an assembly of the type object matches an assembly referenced by the provided assembly name;
mapping from the type object to a class object in a class cache; and
returning the class object as the requested class object.

13. The method of claim 11 wherein issuing, by the classloader, the class_for_name return includes:
determining that a classname associated with a type object in a type cache matches the provided classname;
determining that an assembly of the type object does not match an assembly referenced by the provided assembly name;
loading a new type object in the type cache, wherein the new type object created from the assembly referenced by the provided assembly name;
loading a new class object corresponding to the new type object in the class cache, wherein the new class object maps to the new type object; and
returning the new class object as the requested class object.

14. The method of claim 11 wherein issuing, by the classloader, the class_for_name return includes:
determining that a classname associated with a type object in a type cache does not match the provided classname;
loading a new type object in a type cache, wherein the new type object created from an assembly referenced by the provided assembly name;
loading a new class object corresponding to the new type object in the class cache, wherein the new class object maps to the new type object; and
returning the new class object as the requested class object.

15. One or more computer readable media including computer readable instructions that, when executed, perform the method of claim 11.

16. A method of communication between a program and a classloader during program runtime, comprising:
receiving, by the classloader, a class_from_type call from the program, wherein the class_from_type call includes call parameters comprising a type object associated with a requested class object; and
issuing, by the classloader, a class_from_type return, wherein the class_from_type return includes return parameters comprising the requested class object.

17. The method of claim 16 wherein issuing, by the classloader, the class_from_type return includes:
determining that a classname of a class object in a class cache matches the provided type name;
mapping from the class object having the classname in the class cache to a type object in a type cache;
determining that an assembly of the type object matches an assembly referenced by the provided type object; and
returning the class object as the requested class object.

18. The method of claim 16 wherein issuing, by the classloader, the class_from_type return includes:
determining that a classname of a class object in a class cache matches the provided type name;
mapping from the class object having the classname in the class cache to a type object in a type cache; and
determining that an assembly of the type object does not match an assembly referenced by the provided type object;
loading the provided type object in the type cache, wherein the provided type object is associated with the classname;
loading a new class object in the class cache corresponding to the provided type object, wherein the new class object maps to the provided type object; and
returning the new class object as the requested class object.

19. The method of claim 16 wherein issuing, by the classloader, the class_from_type return includes:
determining that a classname of a class object in a class cache does not match the provided type name;
loading the provided type object in the type cache, wherein the provided type object is associated with the classname;
loading a new class object corresponding to the provided type object in the class cache, wherein the new class object maps to the provided type object; and
returning the new class object as the requested class object.

20. One or more computer readable media including computer readable instructions that, when executed, perform the method of claim 16.
